(19) United States
(12) Patent Application Publication
(10) Pub. No.: US 2016/0269822 A1
(43) Pub. Date: Sep. 15, 2016

(54) Outdoor Directional Mountable Speakers

(71) Applicants: Paul Gorial, Poway, CA (US); Naseem Isteepho, San Diego, CA (US); Jacod Gorial, Poway, CA (US)

(72) Inventors: Paul Gorial, Poway, CA (US); Naseem Isteepho, San Diego, CA (US); Jacod Gorial, Poway, CA (US)

(21) Appl. No.: 14/656,658

(22) Filed: Mar. 12, 2015

(51) Int. Cl. H04R 1/34; H04R 1/02

(52) U.S. Cl. CPC H04R 1/345; H04R 1/028; H04R 1/026; H04R 1/025; H04R 2499/13; H04R 2201/025

(57) ABSTRACT

An outdoor rugged directional speaker system which can attach to any vehicle or sports equipment. Such a device when employed can remove the physical constraints of headphones while conserving privacy and sound pollution and disturbance towards others.

### FIELD OF THE INVENTION

This application claims priority to U.S. Provisional Patent Application Ser. No. 61/951,938 filed on Mar. 12, 2014. The present invention relates generally to outdoor speakers. More particularly, the disclosed device relates to a rugged mountable speaker which is configured to employ directionalized sound which is capable of playing music or sound within a specified angled band and positioning.

### BACKGROUND OF THE INVENTION

### Prior Art

Many sports and outdoors enthusiasts enjoy listening to music during their activities, and as such, a wide array of outdoor speakers and headphones have been developed.

To listen to music, workers on tractors or other construction equipment must employ headphones or a bluetooth headset. Ruggedizing these products however, is expensive and bulky.

Sports enthusiasts such as surfers and snow mobile riders maintain similar requirements for active music listening and must ensure that their devices stay afloat and watertight.

Although rugged speakers and speaker cases are available, they generally project sound radially, disturbing surrounding people with sound pollution and providing the user with dissipated sound mixed with surrounding noise. As such, the listener hears music or other sound with marginal quality mixed with noise. Further, on moving vehicles with two people, both are generally incapable of playing their own music together when outdoors.

Further, in water sports such as surfboarding or jet ski riding, as well as when riding bikes, while speakers currently exist which can mate with a digital music device for providing amplified sound, such devices generally also project sound radially along a line which expands the area of sound mixed with noise as the sound travels further from the loudspeaker. Consequently, in a high noise environment such as during surfing or riding a bike or water craft, the sound such as music generally cannot be heard well if at all by the user who is seated on the surfboard with their head above the speakers and with the significant amount of background noise, as well as the fact that in an outside environment, the projected sound dissipates easily, due to a lack of sound-reflective surfaces.

As such, there is a continuing and unmet need for a rugged watertight sound processing and speaker system which can input sound recorded in digital format communicated from a variety of digital sources such as smartphones and media players and provides a targeted output of generated sound to an area proximate to the ears of a user through directional speakers, targeted speakers or actual sound waves. Such a speaker system should be able to accommodate a wide range of music players. Such a system should be able to safely accommodate such high priced electronic gear in a watertight fashion. Still further, such a device should be formed of durable material which can easily be washed and transported and should be adapted for attaching securely to a wide array of sports and equipment platforms.

The forgoing examples of related art and limitation related therewith are intended to be illustrative and not exclusive, and they do not imply any limitations on the invention described and claimed herein. Various limitations of the related art will become apparent to those skilled in the art upon a reading and understanding of the specification below and the accompanying drawings.

### SUMMARY OF THE INVENTION

The device herein disclosed and described provides a solution to the shortcomings in prior art and achieves the above noted goals of providing a sound amplification and generation system having loudspeakers or speakers which will communicate sound from a digitally input source, or even onboard memory, directly to an area proximate to the user's head and preferably their ears when employed. The device herein is capable of outdoor use in wet or dry environments.

The device is designed to easily but securely affix to an equipment platform such as the top of a surfboard or jet ski, or handlebar of a bicycle or motorcycle, and to receive sound from an electronic memory such as a media player, smartphone, or onboard memory which may be loaded. The digital music or sound files are communicated through a sound processing component and output as sound directionally in a manner configured to provide that sound proximate to the user's ears and/or head. The sound can be directed using positioning of loudspeakers, and/or using processing and output of the generated sound using specialized sound processing which causes a calculated positioning of the generated sound, to an area around or proximate to the user's head. Such sound processing equipment, for instance, is available from LRAD Corporation which is based in San Diego, Calif., and provides audio processing components and loudspeakers for generation of what is known as HyperSonic Sound (HSS).

Such sound processing and projection mixes regular, audible sound, with two beams of super high frequency, inaudible sound waves. The resulting ultrasonic sound wave so generated can then be directed out through loudspeakers in a tightly controlled beam. Wherever the beam makes contact with air, the mixed sound, so generated, reacts with air molecules in a manner that isolates the original audible sound such as that from the digital memory of a smartphone, pad, or onboard memory device.

With HSS sound generation and projection, if a user is positioned in front of the ultrasonic sound wave being projected, they can hear the sound. However, the projection can be so precise, that if the user is a few inches outside the projected beam of sound, they hear nothing. It renders a discernable sound to the user which negates most ambient sounds and provides a clearly discernable rendition of the generated sound from digital memory.

The device herein additionally provides an accessible watertight cavity adapted to electronically engage with the underlying sound processor which generates sound from digital files in electronic memory and communicates such to the loudspeakers. The housing cavity will safely and securely house expensive electronic devices which provide the digital music feed to a connector therein or using wireless transmission, to the sound processor, within a main body.

Employing the device herein, a user can listen to music or sound transmitted from an electronic audio device, which can include, but is not limited to any device having electronic memory for storing digital sound files such as those from a group including cell phones, mp3 players, cd players, dvd players, tape players, smartphones, pad computers, and onboard programmable memory engaged with the sound processor herein.

A secure mounting system is provided allowing that the device may be employed easily on a surfboard or jet ski, motorcycle, bicycle, or other outdoor or indoor sports equipment platform such as where the user and device are both situated together.

In a preferred mode the main body, includes at least two loudspeakers or speakers, which are operatively engaged with the watertight storage cavity, which is sized to contain a large variety of devices with accessible digital memory. If cabled engagement is employed, such includes sufficient cable for the necessary cable bend radius to ensure that the audio port within the watertight storage cavity can properly reach and connect to the audio device. Alternatively, wireless communication may be employed such as WiFi, bluetooth, or light transmission of audio signals or audio files for onboard storage.

In a preferred mode, the watertight storage cavity is designed to house devices which are between 1.5 to 4 inches wide and from 4 to 6 inches in length and from 0.25 to 1 inches in thickness. However it may be adapted as needed to house the respective smartphone, media player or other electronic device having digital sound files onboard in memory which may be communicated to, or accessed by, the device herein.

A transparent sealing lid, which hinges open about the main body, allows for electronic audio device removal or replacement. When closed the lid engages against a seal and renders the cavity watertight. Such a seal may be an o-ring embedded within a recessed face in the main body of the housing, such that the transparent sealing lid's top face remains flush to the top face of the watertight storage cavity in the sealed configuration of the device.

The transparent sealing lid is composed of a clear flat face which contains one or more lid fastening features which can hinge about the main body of the device and may be composed of any durable clear plastic.

A fastening component such as one positioned within the recessed face of the main body, and cooperative lid fastening features within or on the transparent sealing lid can be employed by any durable means which can maintain a constant pressure between the transparent sealing lid and the o-ring to ensure that the device is watertight. The fastening component can include, but is not limited to, a group of such components including biased snaps, screws, nuts, bolts, wing nuts, bands, clasps, and straps.

In a preferred mode, the electronic device housed within the cavity, may be controlled by touching the lid to operate the device as if it were hand held. In another mode, one or more external buttons in a communication with the main body are preferably adapted to allow the user to control the electronic sound processor of the device without opening the watertight storage cavity. Such external buttons should be watertight and durable for outdoor use and can also be employed to turn off the device during storage. Such external buttons may be operatively engaged with a WiFi, infrared, bluetooth or other means for wireless communication with the electronic audio device would be preferred to allow input to the audio device by the user, without opening the watertight storage cavity.

Additionally preferred in the event of a dismount of the device, one or more beacon lights and or audible alarms may be engaged with the main body and can also be configured for employment to prevent the device from being lost outdoors and especially in the ocean among the waves. In a preferred mode, the beacon light and/or audible alarm will begin to report once dismounted such as a strobe light and/or audible pulse, when the dislocation sensor determines that the device has been removed or ejected from the equipment platform to which it has been mounted and such is unintended. The dislocation sensor can be from a group of such sensors including one or a combination of contact sensors, proximity sensors, magnetic sensors or other means to discern an unintentional dismount of the device.

The main body base, preferable also, is configured to provide sufficient buoyancy to ensure that the device remains afloat if dislodged in water. Preferably, in all modes, the main body base is configured with means for removable engagement such as one or more affixing components a bottom side which is closest to the platform for mounting when the device is in an as-used position, which allow the user to adhere the device to an equipment platform.

Such affixing components should be durable but also configured to prevent harm or marring of the equipment platform. For example, such affixing components can be composed of one or a combination of affixing components from a group including suction cups, straps, belts, snaps, clasps, velcro, tape and magnets.

In one preferred mode of the device, sound generated from digital files in onboard memory, or communicated from memory of an engaged device, is communicated to the electronic audio sound processor by wire or wireless communication. Once processed onboard, the electronic signal is communicated to speakers operatively engaged with the housing of the device.

In all preferred modes herein, the speakers are configured and engaged to the housing to generate a directional broadcast of the sound toward the user's head. This may be accomplished with conventional speakers engaged to cones which directionally project the emitted sound, or by the employment of speakers or flat panels adapted to broadcast sound which reacts when it converges upon a target area to produced positive sound which may be heard while virtually eliminating background noise.

Using such directional broadcasting of the produced sound, such may be directed toward and surround the user's head, in a sound bubble so to speak, significantly enhancing what is heard and minimizing surrounding noise. Projection of the sound to form the bubble is accomplished by aiming a positive or targetable sound output such as the noted hypersonic sound generation, which converges adjacent to, or around the user's head.

In one preferred mode, the speakers are configured to emit sound at an angle of between 25 and 55 degrees upwards from the plane of the body of a surfboard, whereas baffles or flares within the main body can further direct sound. Such projection may be by direct line or by reflecting sound projected by the loudspeakers from the surface underlying the device at an angle adapted to intersect an area adjacent to the user's head.

The housing or main body can be composed of any material that is sufficiently durable to withstand the elements and possible falls and collisions, and is as also light enough to be buoyant in sea water and watertight. Such material should be UV resistant so as to survive in the sunlight over time. Such materials one or a combination of materials from a group including wood, polymeric material, plastic, fiberglass, aluminum, steel or carbon fiber, or other materials easily configurable to form the housing or body and speaker projection cones or mounts.

With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other audio player containment structures, methods and systems for carrying out the several purposes of the present disclosed device. It is important, therefore, that the claims be regarded as including such equivalent construction and methodology insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

It is an object of the invention to provide a speaker system adapted for operative engagement with a device holding sound or media digital files in electronic memory.

It is a further object to provide such a speaker system which will house an electronic device in a watertight cavity and with is configured to directionally project the emitted sound at an angle and/or direction position discernable sound with reduced noise adjacent or around the user's head.

Finally, it is an object of this invention for such a speaker system which is adapted for secure but temporary engagement to a large range of outdoor moving platforms without damaging or marring.

These and other objects, features, and advantages of the invention will be brought out in the following part of the specification, wherein detailed description is for the purpose of fully disclosing the invention without placing limitations thereon.

### BRIEF DESCRIPTION OF DRAWING FIGURES

The accompanying drawings, which are incorporated herein and form a part of the specification, illustrate some, but not the only or exclusive, examples of embodiments and/or features. It is intended that the embodiments and figures disclosed herein are to be considered illustrative rather than limiting. In the drawings:

FIG. 1 shows a top isometric view of the device on a platform.

FIG. 2 shows a top isometric view of the device's main body.

FIG. 3 is a top view of the device's main body.

FIG. 4 is a bottom isometric view of the device's main body.

FIG. 5 is an isometric view of the device's transparent sealing lid.

FIG. 6 is a side view of one mode of the device engaged and projecting sound at an angle and in a mode calculated to communicate such proximate to the user's head when riding or sitting on the surface.

FIG. 7 depicts an overhead view of another mode of the device showing the closed housing adapted to hold and engage an electronic device such as a smartphone.

FIG. 8 shows the device of FIG. 7, with a lid opened and depicts an underlying sound processing system for engagement with the housed or a communicating electronic device with accessible digital sound files.

FIG. 9 shows a bottom perspective view of the device of FIG. 7 and angled speakers or covers therefor.

FIG. 10 depicts the device of FIG. 7 from a lower perspective view showing optional side positioned speakers and an operational configuration to engage a camera.

FIG. 11 shows a mode of projecting sound from the device through lower mounted speakers in a manner to bounce from the mounting surface at an angle intersecting the user's head.

FIG. 12 shows another view of the projecting of sound from the device from two sources or speakers in a manner designed to intersect one each with a respective ear or head side of the user.

FIG. 13 depicts the device having an audio processor adapted to generate highly directional and positionable sound such as the noted HSS sound generation to form a bubble of generated sound around the head of the user.

FIG. 14 shows the device of FIG. 7, rotated to position the speakers to a direct line of sound communication toward the user.

### DETAILED DESCRIPTION OF THE PREFERRED EMBODIMENTS OF THE INVENTION

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation.

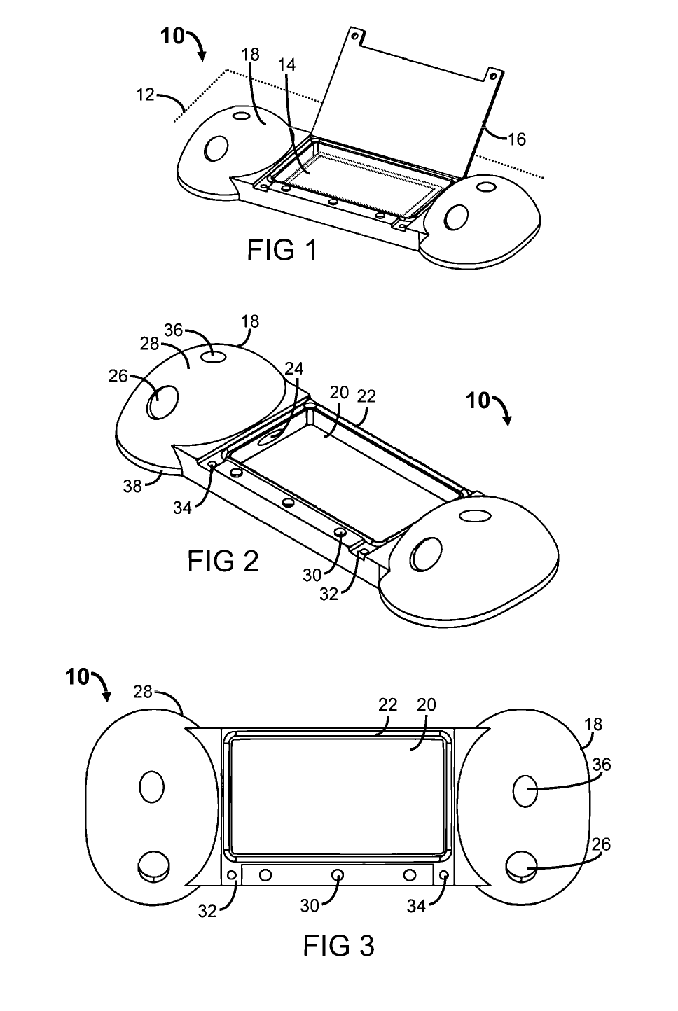

Referring to drawings in FIGS. 1-14 wherein similar components are identified by like reference numerals, there is seen in FIGS. 1 to 3 the device 10 configured for use with a separable fastener providing means for secure removable engagement to an equipment or mounting platform 12 such as on the riding side of a surfboard or jet ski or bicycle, or motorcycle or other outdoor situation. Components included in the device 10 are configured in all modes to project the generated sound stream toward the head and ears of the user 48 in a fashion adapted to converge at a position adjacent to or surrounding the user's head.

The source of the sound generated may be wireless or wired transmission of files or data from electronic memory of an operatively electronically connected audio device 14. The operative connection may be wired or wireless. The audio device 14 may be safely and securely housed within a watertight cavity 20 formed within the housing 18 of the device and which is accessible through disengagement of a secured transparent sealing lid 16.

Employing the device 10 herein, a user 48 can listen to music or sound electronically communicated from an electronic audio device 14. Such audio device 14 might include any for instance from a group including smartphones, cell phones, mp3 players, cd players, DVD players, and tape players and the like. Sound generated from digital files communicated from the audio device 14 may be listened to while the user 48 is seated on or near the equipment where the device 10 engaged using a separable engagement or fastener 13 attached such as to a platform 12 such as the riding surface of a surfboard or jet ski or bicycle or motorcycle. As can be discerned, the device may be employed in any scenario where the user 48 prefers speakers over headphones.

As such an equipment platform 12 can include, but is not limited to, any moving devices such as sports equipment, vehicles, platforms, rigs or means of transportation, especially in cases where the user 48 and device 10 are outdoors.

Per FIGS. 2 and 3, in one mode of the device 10 the housing 18 includes one, but preferably at least loudspeakers or components adapted to receive an electronic signal and generate sound waves which are projected to a determined convergence point such as the head of the user 48. The term speakers 26 is employed herein for the components generating sound waves which may be heard by the user and encompasses any such device available such as transducer or cone speakers, flat panel loudspeakers, and speakers capable of both conventional sound generation and HSS sound generation which is audible upon convergence at a determined point, or inline with the axis of projection of the speaker 26. Any speaker 26 configuration as would occur to those skilled in the art is considered included herein.

In the device 10 the speakers 26 may be engaged operatively with the housing 18 such as in housing lobes 28, are positioned adjacent a watertight storage cavity 20, which is sized to securely contain a large variety of audio devices 14. If the audio device 14 is in wired engagement with the device 10, this additionally allows for the necessary cable bend radius to ensure that the audio port 24 within the watertight storage cavity 14 can properly reach and connect to the audio device 14. Of course the electronic sound signal can also be communicated by wireless means such as fiber optic or RF transmission to an onboard wireless receiver 25 (FIG. 8).

In one preferred mode, the watertight storage cavity 20 is designed with a width, length and depth of between 1.5 to 4 inches, 4 to 6 inches and 0.25 to 1 inches respectively. A transparent sealing lid 16, which hinges open about the housing 18 for electronic audio device 14 removal or replacement, seals against an o-ring 22 embedded within a recessed face 32 in the housing 18 such that the transparent sealing lid's 16 face is in sealed engagement with a mating face of the watertight storage cavity 20 in the sealed configuration of the device 10.

As seen in FIG. 5, the transparent sealing lid 16 is composed of a clear flat face 44 which contains one or more lid fasteners 46 to maintain it closed, and can rotate on a hinged engagement about the housing 18 of the device 10. The lid 16 is preferably transparent in order that the user may view the video screen on the audio device 14 when housed therein. A polymer which will communicate user touch of the lid 16 to the screen of a housed audio device 14 may also be used if control of the audio device 14 sealed in the cavity 20 is desired.

A separable fastener 34 such as a recessed face 32 of the housing 18, configured to cooperatively engage with the lid fastener 46 within the transparent sealing lid 16 can be employed and is formed by any durable means which when engaged can maintain a constant pressure between the face of the transparent sealing lid 16, and a raised surface of an o-ring 22 to ensure that the device 10 is watertight. The separable fastener 34 may be one or a combination of fastening components from a group including screws nuts, bolts, wing nuts, bands, clasps, snaps, and straps, or any such fastener which would occur to those skilled in the art as providing a securement which will maintain the seal.

If the device 10 does not allow for control of the housed audio device 14 by touch of the lid 16 or remote control, one or more external buttons 30 within the housing 18 allow the user 48 to control the electronic audio device 14 without opening the watertight storage cavity 20. Such external buttons 30 should be watertight and durable for outdoor use and are configured for operative engagement with the audio device 14 within the cavity 20.

Such operable engagement can also include one or a combination of operative connections from a group including wired connections and wireless connections. For instance, RF might be employed in the form of WiFi or bluetooth signals which when received by the audio device 14 control it, or light based signals might be employed. The external buttons 30 may also be employed to turn off the audio device 14 and any amplification components if employed which are engaged to the device 10.

Additionally preferred, one or more means to provide a beacon to the user may be engaged with the device 10 such as beacon 36 engaged to a point on the device 10 such as with the housing 18. Such a beacon 36 may be visual in the form of a light or strobe, and/or audio in the form of a noise maker such as a buzzer, beeper, or klaxon. The beacon 36 will activate and is employed to prevent the device 10 from being lost outdoors and especially if dismounted from a surfboard or jet ski within the ocean among the waves. In a preferred mode, the beacon 36 will begin to strobe and/or pulse noise when the dislocation sensor 42 determines that the device has been unintentionally removed or ejected from the equipment platform 12 and is floating in water.

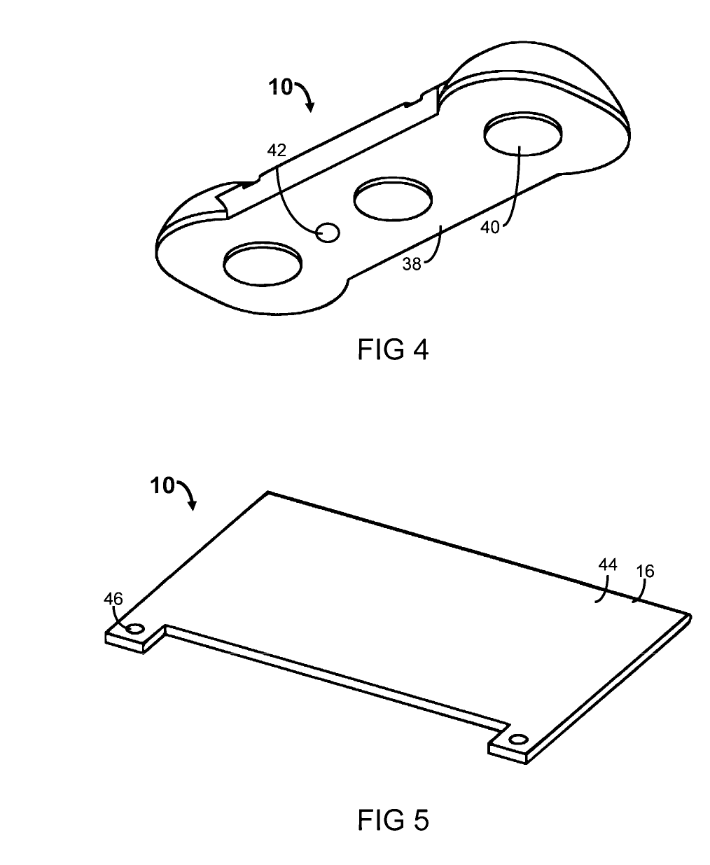

A dislocation sensor 42 per FIG. 4 can be composed of one or a combination of switches from a group including contact sensors, proximity sensors, magnetic sensors, liquid sensors, potentiometers, or other sensors which can determine an unintentional dismount of the device 10 from a separable fasteners 13 or a mount to a surface 12.

In all modes of the device of FIGS. 1-14, the housing base 38 extending from the housing 18, or the housing 18 is formed in a manner and of material which provides sufficient buoyancy to the device 10 with an audio device 14 within the cavity 20, to ensure that the device 10 floats and remains mostly above water when afloat so it may be found quickly.

Additionally, per FIG. 4, in one mode, the main body base 38 contains one or more affixing features 40 extending from a side surface which allow the user 48 to securely but removably engage the device 10 to an equipment platform 12 such as the planar surface of a surfboard or a surface of a jetski or other water traversing device.

Such affixing features 40 should provide an easily achievable secure mount and be durable in the sunlight and aquatic environment in which the device operates. However, the affixing features 40 should also be formed in a manner to prevent harm or marring the equipment platform 12. Currently preferred, the affixing features 40 may be formed of one or a combination of a group of affixing components including suction cups, straps, belts, snaps, clasps, velcro, tape or magnets.

Sound is communicated electronically from the electronic audio device 14, may be routed to an onboard sound processor 41 connected to onboard electric power 43, and can include electronic components and an amplifier, to provide a sound signal to the speakers 26 to generate the directionally locatable sound toward the user 48. In one preferred mode, the speakers 26 are designed for directional projection of sound using tunnels or cones, or signal generation such as with HSS sound noted above, to achieve a sound convergences adjacent and or around the head of the user 48.

Such may be accomplished mechanically using cones in front of conventional speakers 26 or employing speakers 26 which project HSS encoded or negative sound which is only audible upon convergence of the two projected sound paths, or when the head is positioned within each individual soundpath, and which may be aimed to converge at or adjacent the user's head. In this fashion the sound from projected from the device 10 may be targeted and tailored to project adjacent the head of the user, and be heard in noisy outdoor venues such as at the beach with large waves or riding a jet ski with engine noise.

In a preferred mode, the speakers 26 as noted, are configured to emit sound at an angle to converge at or hear the user's head. Currently, this has been discerned to be between 35 and 55 degrees upwards from the bottom of the housing 18 when engaged to a surface 12 such as a surfboard. Additionally, baffles or flares within or cones or tunnels formed with the housing 18 in front of the rearward positioned speakers 26 may further direct reflected sound.

The housing 18 can be composed of any material that is sufficiently durable to withstand the UV and aquatic use elements and possible falls and collisions, and is as also light enough to be buoyant in sea water and watertight. Such materials can be selected from a list including but not limited to: wood, plastic, fiberglass, aluminum, steel or fiber.

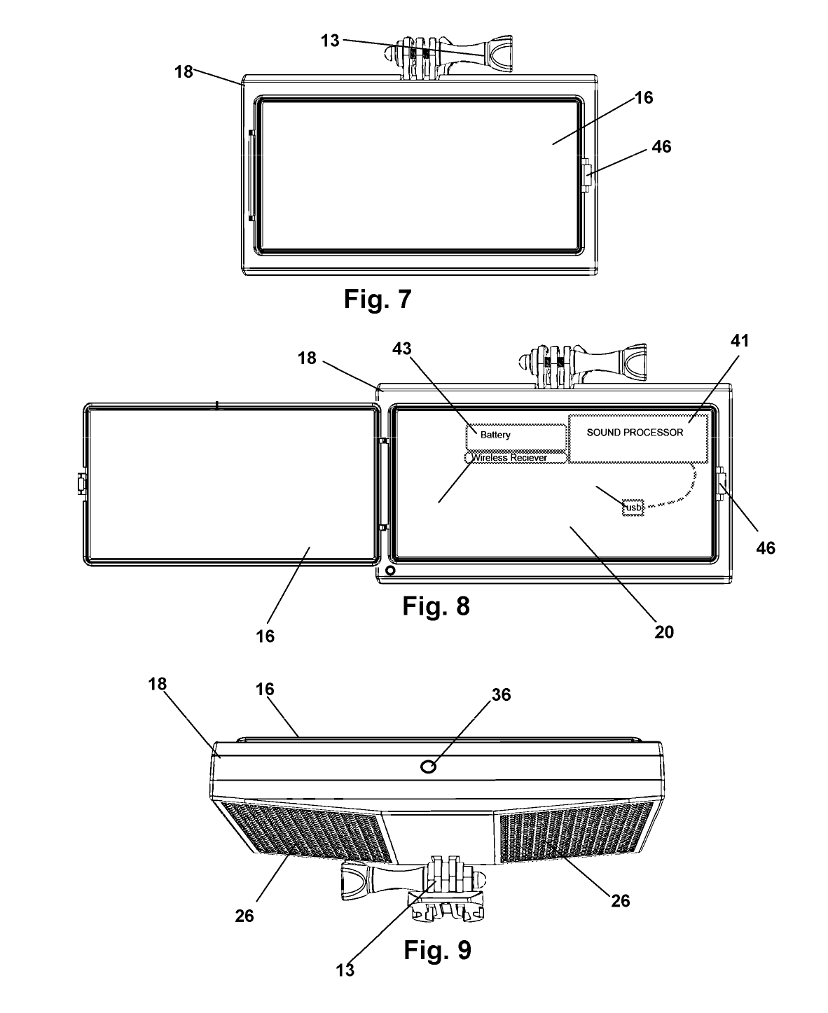

As noted, FIG. 7 depicts an overhead view of another mode of the device 10 showing the closed housing 18 adapted to hold and engage an electronic device such as a smartphone within a watertight cavity underneath the depicted lid 16. This can be seen in FIG. 8 which shows the device of FIG. 7, with the lid 16 opened to reveal the cavity 20. Also shown are an underlying sound processor 41, and power source 43 system for operative electronic engagement with the housed or a communicating audio device 14 with accessible digital sound files. An audio port 24 or a wireless receiver 25 may be provided to communicate digital sound files to the device 10 as noted.

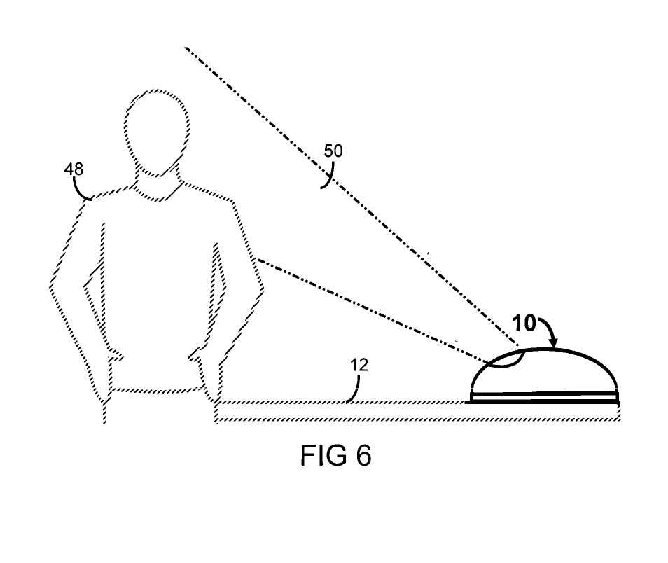

FIG. 9 shows a bottom perspective view of the device of FIG. 7 and depicts the speakers 26 mounted therein. The housing 18 may be employed in positions to reflect sound as in FIGS. 11-13 or positioned to project sound directly at the user 48 such as in FIG. 6.

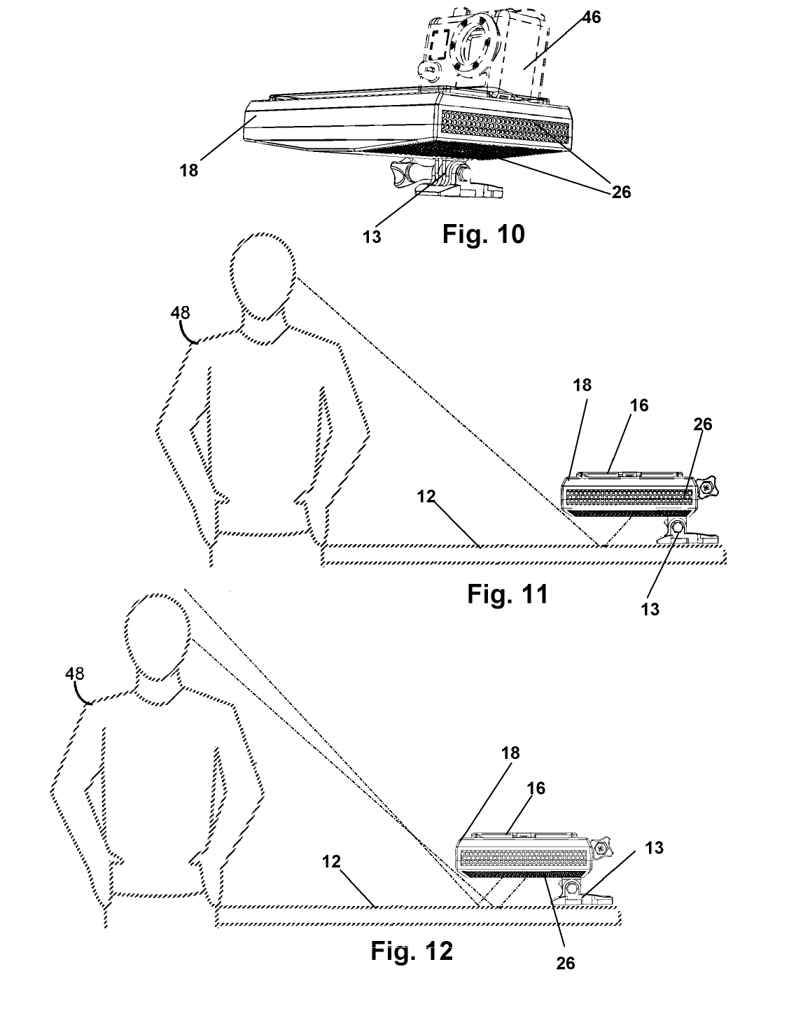

Shown in FIG. 10 is the device 10 as in FIG. 7 from a lower perspective view. In this view, the optional side positioned speakers 26 can be seen. Also shown is an optional engagement of a camera, 45.

FIGS. 11-13 depict reflection-directing of generated sound toward the user 48 in various modes. In FIG. 11 is shown a mode of projecting sound from the device 10 through lower mounted speakers 26 in an angled manner calculated to bounce from the mounting surface 12 at an angle wherein the projected sound intersects the user's head.

In FIG. 12 shows another view of the projecting of sound from the device 10 from two sources or speakers 26 in a manner designed to intersect one sound stream each with a respective ear or head side of the user 48. Where two streams may intersect to form a sound, the angles of FIG. 12 may be adapted to such.

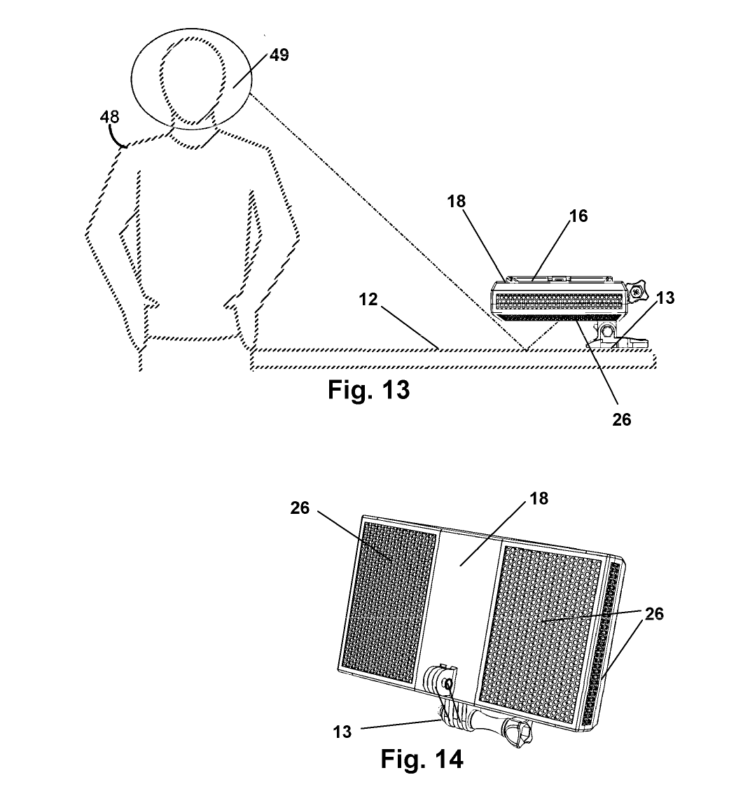

FIG. 13 depicts the device 10 having an audio processor 41 adapted to generate highly directional and positionable sound such as the noted HSS sound generation. In this mode a bubble 49 of generated sound around the head of the user 48 can be achieved by reflected sound as in FIG. 13 or may also be achieved by positioning the device as in FIG. 14 for direct projection of sound streams for bubble 49 formation.

As noted the device of FIG. 7, preferably employs a rotatable separable fastener 13 which allows the housing 18 to be rotated relative to the surface 12. As shown in FIG. 14 the device of FIG. 7, using this rotatable engagement may be rotated to position the speakers 26 to direct a stream of sound communication directly toward the user 48.

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. An audio apparatus comprising:
a housing;
a cavity positioned on a first side of said housing, said cavity having a perimeter edge bounding a recessed area;
a lid positionable to a sealed engagement with said perimeter edge;
said cavity adapted to removably hold an electronic audio device having digital audio files in electronic memory;
at least one loudspeaker engaged with said housing;
a connection to engage an electronic signal output of said electronic audio device to said speaker;
a rotational engagement of said housing to a mount;
said speaker configured to direct a stream of sound generated by said speaker from said electronic signal output; and
said housing positionable in said rotational engagement to direct said stream of sound along a line to intersect or run adjacent to a head of a user, whereby a said audio device positioned within said cavity communicates sound generated from said digital audio files in said electronic signal output to said speaker which emits said sound stream thereby enhancing hearing by said user of said sound in a noisy or outdoor environment.

2. The audio apparatus of claim 1, wherein said mount is engaged with a surface, and said speaker being positionable by a rotation of said mount to direct said sound stream toward said surface at an angle of incidence causing a reflection of said sound stream along said line to intersect or run adjacent to said head of said user.

3. The audio apparatus of claim 1, wherein said connection to engage an output of said electronic audio device to said speaker comprises:
a wired or wireless connection between said output of said electronic audio device and a sound processor positioned in said housing;
a power source engaged with said housing and in operative communication with said sound processor; and
said sound processor configured to amplify said electronic signal output communicated to said speaker, whereby decibel level of said stream of sound is increased thereby rendering said sound heard by said user louder.

4. The audio apparatus of claim 2, wherein said connection to engage an output of said electronic audio device to said speaker comprises:
a wired or wireless connection between said output of said electronic audio device and a sound processor positioned in said housing;
a power source engaged with said housing and in operative communication with said sound processor; and
said sound processor configured to amplify said electronic signal output communicated to said speaker, whereby decibel level of said stream of sound is increased thereby rendering said sound heard by said user louder.

5. The audio apparatus of claim 3, wherein said sound processor generates said signal output to said speaker in a manner generating a hypersonic stream of sound from said speaker; and
said hypersonic stream of sound generating said sound which is audible only upon convergence of said hypersonic stream of sound with said head of said user.

6. The audio apparatus of claim 4, wherein said sound processor generates said signal output to said speaker in a manner generating a hypersonic stream of sound from said speaker; and
said hypersonic stream of sound generating said sound which is audible only upon convergence of said hypersonic stream of sound with said head of said user.

7. The audio apparatus of claim 5, wherein said mount is engaged to the riding side of a surfboard and said housing includes a beacon activated by a detachment of said housing from said mount or said mount from said surfboard.

8. The audio apparatus of claim 6, wherein said surface is a surfboard and said housing includes a beacon activated by a detachment of said housing from said mount or said mount from said surfboard.
